(19) United States
(12) Patent Application Publication
(10) Pub. No.: US 2023/0296876 A1
(43) Pub. Date: Sep. 21, 2023

(54) SYSTEM AND METHOD FOR IMAGING THROUGH SCATTERING MEDIUM

(71) Applicant: ZSQUARE LTD., Petah Tikva (IL)

(72) Inventors: Zeev ZALEVSKY, Rosh Ha'ayin (IL); Asaf SHAHMOON, Petah Tikva (IL); Amihai MEIRI, Ramat Hasharon (IL); Oran HERMAN, Givat Shmuel (IL); Shimon ELKABETZ, Kiryat Ono (IL); Arkady RUDNITSKY, Rehovot (IL)

(73) Assignee: ZSQUARE LTD., Petah Tikva (IL)

(21) Appl. No.: 17/696,935

(22) Filed: Mar. 17, 2022

(51) Int. Cl. G02B 23/24

(52) U.S. Cl. CPC G02B 23/243; G02B 23/2484

(57) ABSTRACT

A system for imaging through a scattering medium may include a spatial and temporal coherent light source for generating an illumination beam to illuminate an object to be imaged through a scattering medium, so as to project an array of spots on the object; an imaging sensor for capturing an image of the object; a first optical setup to capture light transmitted through or reflected off the object and focus the captured light onto a diffractive optical element (DOE) configured to transmit ballistic photons of the captured light arriving from the object while blocking scattered photons; and a second optical setup for capturing light transmitted by the DOE and focus that light onto an imaging plane of the imaging sensor.

### FIELD OF THE INVENTION

The present invention relates to imaging, e.g., endoscopy, and more particularly to a system and method for imaging through a scattering medium.

### BACKGROUND OF THE INVENTION

Endoscopes, which are widely used in medical diagnostics and in other medical procedures, are typically aimed at providing the medical expert, or medical team, with a clear image of an examined internal hollow organ or cavity inside a subject's body.

There are various known kinds of endoscopes. Typically, an endoscope is made up of a flexible tube that includes an optical guide for transmitting light from an illumination source to the distal end of tube, which is inserted into the subject's body, so as to illuminate the inspected surface inside the body, and an optical guide for transmitting reflected light off the illuminated surface to an eyepiece or to an optical sensor that is a part of an optical system for processing the reflected light and displaying an image of the illuminated surface. Many endoscopes employ optical fibers as their optical guides for illumination as well as for transmission of the light reflected of the inspected surface inside the body.

Multicore fiber endoscopes are known, which include a bundle of optical fibers, which are used for transmitting light reflected off the inspected surface to the eyepiece or to the display device.

Typical optical imaging systems include an optical set up that is designed to focus light reflected or emitted from an imaged object onto an optical sensor (or screen). Typically, when imaging is carried out in a non or barely scattering medium, the signal-to-noise ratio (SNR) is large enough to obtain a good image of the object. However, in a scattering medium, such as, for example, blood, blinding emissions from non-object planes may be defocused to the image plane, thus greatly affecting the SNR, reducing contrast in the desired image, and at times even completely ruining the resulting image.

Another problem associated with imaging through a scattering medium is reduced imaging resolution, which may not be enhanced by applying known super-resolution techniques due to the low SNR.

It may be desired to provide systems and methods for enhancing imaging through a scattering medium.

### SUMMARY OF THE INVENTION

There is thus provided, according to some embodiments of the present invention, a system for imaging through a scattering medium. The system may include a spatial and temporal coherent light source for generating an illumination beam to illuminate an object to be imaged through a scattering medium, so as to project an array of spots on the object. The system may also include an imaging sensor for capturing an image of the object. The system may also include an optical arrangement. The optical arrangement may include a first optical setup to capture light transmitted through or reflected off the object and focus the captured light onto a diffractive optical element (DOE) configured to transmit ballistic photons of the captured light arriving from the object while blocking scattered photons. The optical arrangement may also include a second optical setup to capture light transmitted by the DOE and focus that light onto an imaging plane of the imaging sensor.

According to some embodiments of the invention, the DOE comprises an array of diffractive lenses.

According to some embodiments of the invention, the array of diffractive lenses comprises rows and columns of diffractive lenses.

According to some embodiments of the invention, the diffractive lenses are located at intersections of the rows and columns, each diffractive lens is defined by a circular edge and comprises a toroidal groove surrounding a central circular raised plateau.

According to some embodiments of the invention, the first optical setup is a magnifying optical setup.

According to some embodiments of the invention, a dimension of each diffractive lens of the array of diffractive lenses equals a dimension of a spot of the array of spots multiplied by a magnification of the magnifying optical setup.

According to some embodiments of the invention, the light source is a laser source.

According to some embodiments of the invention, the laser source is a pulsed laser source.

According to some embodiments of the invention, the system is further configured to cause the illumination source and the optical arrangement to perform lateral shifts in a plane substantially orthogonal to a direction of the illumination beam.

According to some embodiments of the invention, the system further includes one or more vibrators to cause the lateral shifts.

According to some embodiments of the invention, the system further includes a guide wire to cause the lateral shifts.

According to some embodiments of the invention, the guide wire is configured to facilitate scanning of the object.

According to some embodiments of the invention, the system further includes a displacer to displace the light source and an objective end of the optical arrangement to perform scanning of the object.

According to some embodiments of the invention, the displacer is configured to displace the light source and the objective end of the optical arrangement in a plane substantially orthogonal to a direction of the illumination beam.

According to some embodiments of the invention, the displacer is configured to displace the light source and the objective end of the optical arrangement along an axis substantially parallel to a direction of the illumination beam.

According to some embodiments of the invention, the system further includes a controller for controlling the light source.

According to some embodiments of the invention, the controller is also configured to control the imaging sensor.

According to some embodiments of the invention, the system is incorporated in an endoscope.

According to some embodiments of the invention, a method is provided for imaging through a scattering medium, the method may include generating by a spatial and temporal coherent light source an illumination beam to illuminate an object to be imaged through a scattering medium, so as to project an array of spots on the object. The method may also include capturing by a first optical setup of an optical arrangement light transmitted through or reflected off the object and focusing the captured light onto a diffractive optical element (DOE) configured to transmit ballistic photons of the captured light arriving from the object while blocking scattered photons. The method may also include capturing by a second optical setup of the optical arrangement light transmitted by the DOE and focusing that light onto an imaging plane of an imaging sensor. The method may also include capturing the focused image by the imaging sensor.

### BRIEF DESCRIPTION OF THE DRAWINGS

In order the present invention to be better understood and its practical applications appreciated, the following figures are provided and referenced hereafter. It should be noted that the figures are given as examples only and in no way limit the scope of the invention. Like components are denoted by like reference numerals.

FIG. 1A is a schematic illustration of a system for imaging through a scattering medium, according to some embodiments of the present invention.

FIG. 1B is a schematic illustration of a system for imaging through a scattering medium, according to some embodiments of the present invention, embodied in an endoscope.

FIG. 1C is a photographed image of a diffractive optical element (DOE) for use in a system for imaging through a scattering medium, according to some embodiments of the present invention.

FIG. 1D is a schematic front view of a lenslet of a DOE for use in a system for imaging through a scattering medium, according to some embodiments of the present invention.

FIG. 1E is a cross-sectional view of a lenslet of a DOE for use in a system for imaging through a scattering medium, according to some embodiments of the present invention.

FIG. 2A is a photographed image of a hole pattern (raster) covered by a diffuser, analogues to a 0.5 mm scattering milk layer, imaged by the system of FIG. 1A, without the diffractive optical element.

FIG. 2B is a graph showing the gray scale value across the line (pixel distance) shown in the image of FIG. 2A.

FIG. 3A is a photographed image of a hole pattern (raster) covered by a diffuser, analogues to a 0.5 mm scattering milk layer, imaged by the system of FIG. 1A, with the diffractive optical element.

FIG. 3B is a graph showing the gray scale value across the line (pixel distance) shown in the image of FIG. 3A.

FIG. 4A is a photographed image of a hole pattern (raster) covered by a diffuser with a greater diffusing angle than the diffuser used for FIG. 3A, imaged by the system of FIG. 1A, without the diffractive optical element.

FIG. 4B is a graph showing the gray scale value across the line (pixel distance) shown in the image of FIG. 4A.

FIG. 5A is a photographed image of a hole pattern (raster) covered by a diffuser with a greater diffusing angle than the diffuser used for FIG. 3A, imaged by the system of FIG. 1A, with the diffractive optical element.

FIG. 5B is a graph showing the gray scale value across the line (pixel distance) shown in the image of FIG. 5A.

FIG. 6 is a schematic illustration of a system for imaging through a scattering medium, according to some embodiments of the present invention, embodied in an endoscope with an illumination source.

FIG. 7 is a diagram of a controller that may be incorporated in a system for imaging through a scattering medium, according to some embodiments of the present invention.

### DETAILED DESCRIPTION OF THE INVENTION

In the following detailed description, numerous specific details are set forth in order to provide a thorough understanding of the methods and systems. However, it will be understood by those skilled in the art that the present methods and systems may be practiced without these specific details. In other instances, well-known methods, procedures, and components have not been described in detail so as not to obscure the present methods and systems.

Although the examples disclosed and discussed herein are not limited in this regard, the terms “plurality” and “a plurality” as used herein may include, for example. “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”. “associating” “selecting,” “evaluating,” “processing,” “computing,” “calculating.” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

According to some embodiments of the present invention, systems and methods for imaging through a scattering medium are designed to combine SNR improving techniques and super-resolution techniques to obtain enhanced images.

In a realistic imaging scenario, a pulse of light is projected through a scattering medium towards an object to be imaged. As a result of scattering in the medium, the pulse stretches and may be described by ballistic, snake and diffusive signal components. Ballistic components take the shortest path through the medium and preserve image information. In contrast, diffusive light undergoes numerous scatterings, travels long distances inside the scattering medium and does not contribute towards forming a direct image. Snake photons undergo some scatterings in the forward direction, hence retaining some image information. The light then impinges on the object and is scattered back or transmitted towards a sensor through the scattered medium again. Again, the signal stretches and can be described by ballistic, snake and diffusive photons.

Thus, light that reaches the imaging sensor is made up of ballistic, snake and diffusive signal components, affecting poor SNR.

According to some embodiments of the present invention a system for imaging through a scattering medium is provided, that includes an optical set-up configured to provide an extremely shallow focal depth, where practically only a predefined plane orthogonal to the direction of the illumination beam is in focus. The imaging system is configured to allow only photons incoming from the plane in focus to reach the imaging sensor, while filtering out photons incoming from other planes.

According to some embodiments of the invention, a system for imaging through a scattering medium is configured to use a spatially and temporally coherent illumination source to project an array of spots on an object to be imaged that is behind a scattering medium. The scattering medium separates the object from the illumination source imaging, as well as separating the object from the imaging optics.

For example, for a scattering medium like blood, the illumination source may be a pulse laser that is configured to generate a light beam with a wavelength in the range of 800-850 nm. e.g., 830 nm.

In order to obtain an array of spots, the light source is configured to direct an illumination beam of pulse laser, while rapidly shifting in short steps (e.g., vibrating) along one or more lines in the X-Y plane, substantially orthogonal to the Z axis, which is the illumination direction of the illumination beam.

As a result of the interaction of the illumination beam with the scattering medium, and the rapid lateral vibration of the illumination source, an array of spots is formed on the object.

The imaging part of the system for imaging through a scattering medium may include an optical arrangement. The optical arrangement may include a first optical set up configured to capture light transmitted through or reflected off the object and focus the captured light onto a diffractive optical element (DOE) configured to transmit ballistic photons of the captured light arriving from the object while blocking scattered photons. The optical arrangement may also include a second optical setup configured to capture light transmitted by the DOE and focus that light onto an imaging plane of an imaging sensor.

A system for imaging through a scattering medium, according to some embodiments of the invention, may be configured to facilitate combined lateral shifting (substantially in the X-Y plane) of both the illumination source and the optical arrangement to perform transversal scan of the array of spots, in order to further improve resolution and even obtain super resolution.

A system for imaging through a scattering medium, according to some embodiments of the invention, may be configured to facilitate combined shifting along the Z axis substantially coaxially to the direction of the illumination beam to allow reconstruction of 3D image of the imaged object.

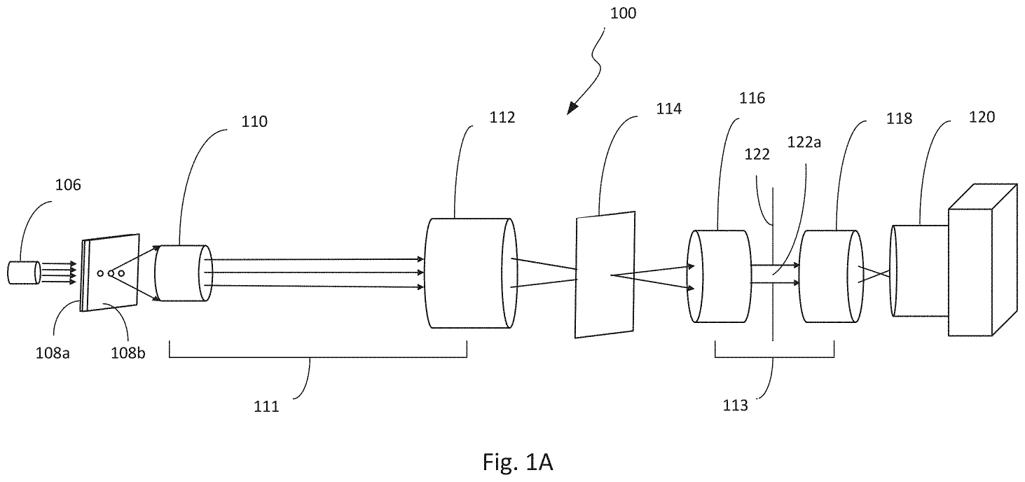

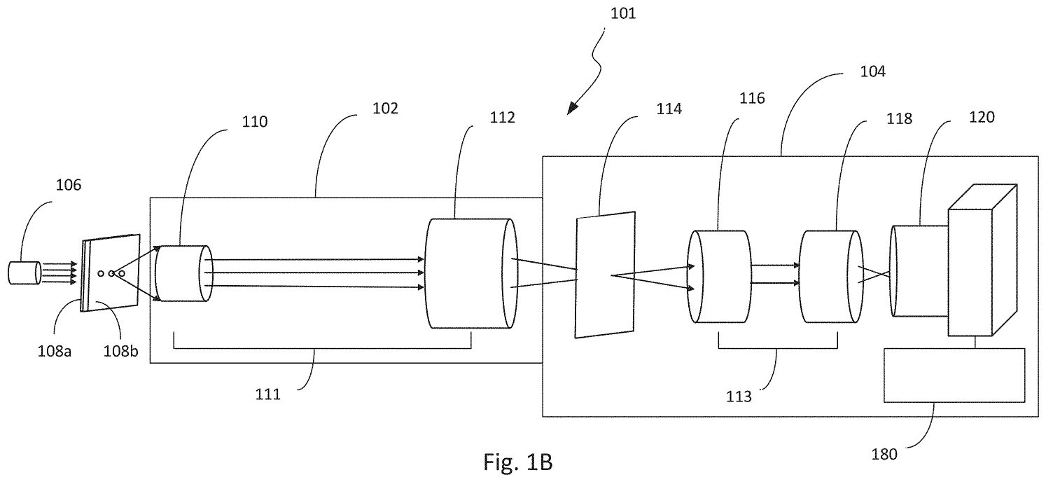

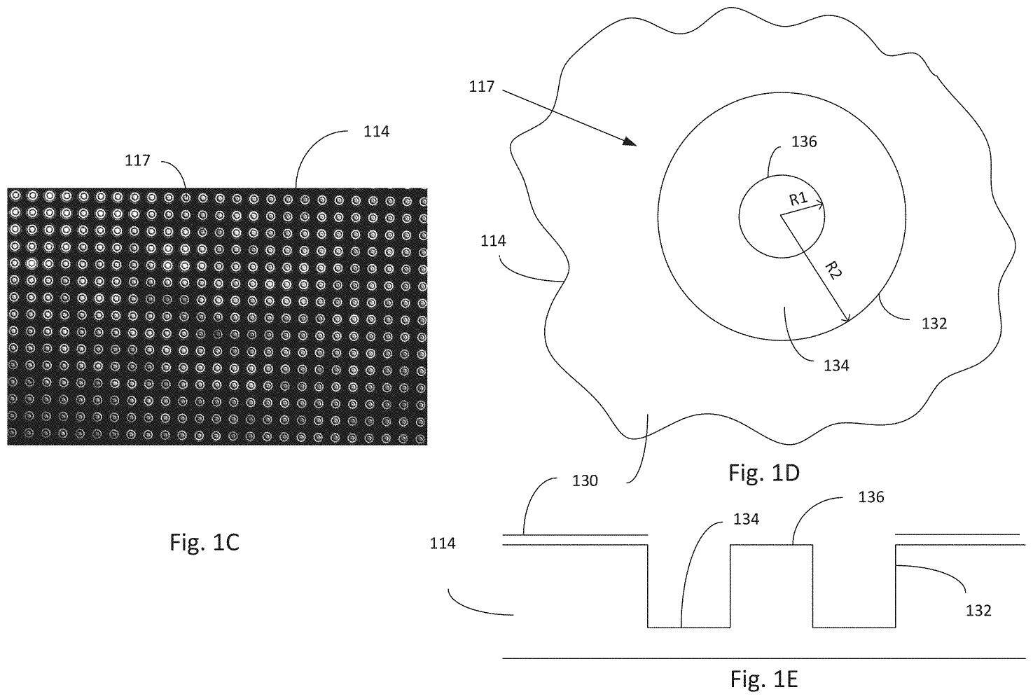

FIG. 1A is a schematic illustration of a system 100 for imaging through a scattering medium, according to some embodiments of the present invention.

System 100 may be configured to image an object through a scattering medium, for example object 108a. The system depicted in FIG. 1A is a setup, that was used for testing, in which diffuser 108b simulated a diffusing medium. Light source 106 is provided to illuminate object 108a. Light source 106 may be configured to illuminate the object from behind the object or facing the object—with respect to the rest of the optical setup of the system. Thus, light may be transmitted through the object (when illuminated from behind, if the object is transparent or semi-transparent) or be reflected off the object (when illuminated from the front). Light source 106 may be part of system 100 or provided separately. In some embodiments of the invention, light source 106 is a laser source

In a test that was carried out using a setup resembling the setup depicted in FIG. 1A the object was a raster made of an opaque film with an array of transparent points of known size and pitch, simulating a desired resolution for the system for imaging through scattering medium, according to some embodiments of the invention.

System 100 may include a magnifying optical setup 111, a diffractive optical element (DOE) 114 guiding optics 113 and an imaging sensor 120, which are aligned, in that order, to define an optical path for light coming from an object to be imaged.

Magnifying optical setup 11, e.g., a microscope, is configured to provide a known magnification and may include lenses 110 and 112 defining a fixed or adjustable focal length.

System 100 also includes a diffractive optical element (DOE) 114, which may be positioned at a distance from ocular lens 112 of the magnifying optical setup 111 defined by, or adjustable to coincide with, the focal length of the magnifying optical setup 111, in other words, the DOE is positioned in the image plane of the first optical setup so that light emitted from (e.g., transmitted through or reflected off) an object, positioned in front of the magnifying optical setup 114 (e.g., object 108a) at a distance from the objective lens 110 that is equal to the focal length of magnifying optical setup 114, is focused on DOE 114.

DOE 114 may comprise a lenslet array, that includes an array of lenslets arranged in a grid of lines of columns, each lenslet located at an intersection of a line and a column of the grid, having a pitch corresponding to a desired resolution. The pitch of the lenslet array may be calculated to be the desired pitch multiplied by the magnification factor of the magnifying optical setup 111. The lenslets are embedded in an opaque material that prevents any stray light from transmitting through the DOE 114.

DOE 114 is configured to only allow light-rays originating from the imaged object to pass. More particularly, DOE 114 is configured to only allow light-rays originating from a grid of coplanar points on the imaged object whose pitch defines the desired resolution to be transmitted through the DOE 114. The configuration of the magnifying optical setup 111 and the DOE 114 is designed to mainly allow ballistic photons arriving directly from the coplanar points on the imaged object to be transmitted through DOE 114, whereas scattered photons are more likely to be blocked, thereby increasing the SNR.

Light transmitted through DOE 114 may then be directed via optical guide 113 that may include one or a plurality of lenses and projected onto the imaging plane of imaging sensor 120.

Optical guide 113 may include an aperture 122, for further blocking stray light rays, allowing only light rays traveling at the center, within the perimeter 122a of the aperture, to be transmitted. Optical guide 113 is configured to focus the light transmitted through on the imaging plane of imaging sensor 120.

FIG. 1B is a schematic illustration of a system for imaging through a scattering medium, according to some embodiments of the present invention, embodied in an endoscope.

In some embodiments of the present invention, an endoscope 101 is provided, that includes magnifying optical setup 111. DOE 114, optical guide 113 and imaging sensor 120. In some embodiments of the invention magnifying optical setup 111 is incorporated in a flexible insertion tube 102, comprising, for example, single or multicore optical fibers, of the endoscope that is configured to be inserted into a cavity of a subject's body, for example, into a blood vessel, a bladder, kidney, bronchus, joint, colon, etc. In some embodiments of the present invention the DOE, the optical guide set-up and the imaging sensor may be located at a hand-held or automated control body 104 of the endoscope, which may be located outside the subject's body, to which the insertion tube 102 is linked and optically coupled. Controller 180 may be provided to control components of the endoscope, such as the imaging sensor 120, illumination source 106, and/or other components.

FIG. 1C is a photographed image of a DOE 114 for use in a system for imaging through a scattering medium, according to some embodiments of the present invention. DOE 114 comprises a plurality of lenslets 117, arranged in an array defined by lines and columns, where each lenslet 117 is located at an intersection of a line and a column of the lines and columns of the array.

FIG. 1D is a schematic front view of a lenslet 117 of a DOE for use in a system for imaging through a scattering medium, according to some embodiments of the present invention. FIG. 1E is a cross-sectional view of a lenslet of a DOE for use in a system for imaging through a scattering medium, according to some embodiments of the present invention. Lenslet 117 may be formed in a transparent material (e.g., fused silica) while having areas between lenslets 117 covered by an opaque material (e.g., aluminum film) 130. Lenslet 117 is defined by circular edge 132 and includes a toroidal groove 134 (e.g., a square toroid) surrounding a central circular raised plateau 136. The dimensions of the lenslet may be configured to successfully diffract laser light in a specific wavelength. For example, in some embodiments of the present invention, the outer radius R2 of a lenslet 117, at the circular edge 132, may be between 30-50 nm (e.g., 40 nm), and the radius R1 of the central circular raised plateau 136 may be between 15-25 nm (e.g., 22 nm), when using a laser source (e.g., 830 nm laser diode), and the pitch of the lenslet array may be, for example, between 110-150 nm (e.g., 127 nm). The above measurements are given as an example without limiting the scope of the present invention to other measurements. The dimensions of the lenslet array may correlate to the dimensions of the object to be imaged, which, in some embodiments of the present invention is an array of points or patches. In some embodiments of the invention the dimensions (e.g., the pitch) of the lenslet array is designed to be equal to the pitch of the imaged array of points or patches multiplied by the magnification of the magnifying optical set up 111.

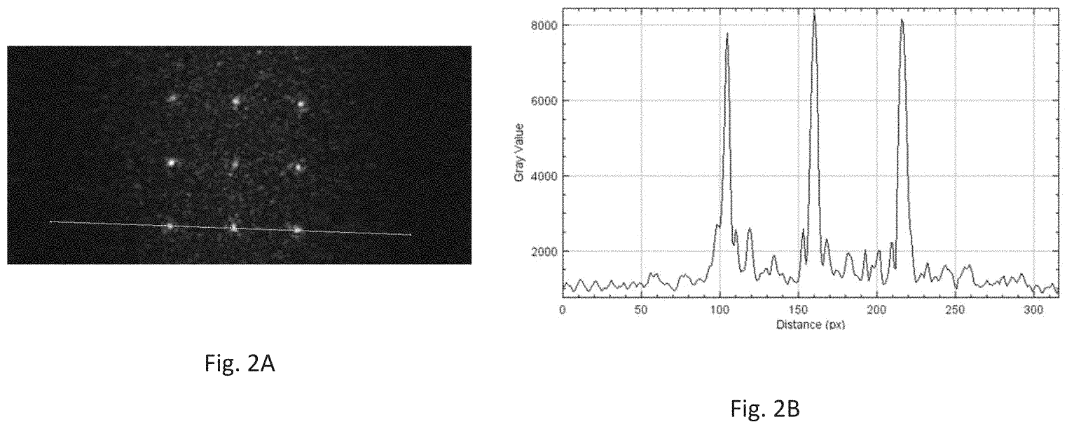

FIG. 2A is a photographed image of a hole pattern (raster) covered by a diffuser, analogues to a 0.5 mm scattering milk layer, imaged by the system of FIG. 1A, without the diffractive optical element. The hole pattern may be clearly seen in the image (three rows of three bright dots surrounded by evident noise. FIG. 2B is a graph showing the gray scale value (intensity readout) across the line (pixel distance) shown in the image of FIG. 2A. It is evident from the graph, that in this example, peaks corresponding to the hole pattern reached up to about 8000, whereas the noise ranged between 200 to 2000, which is about 1/7 of the signal peaks, so that SNR (for the two-dimensional image) is given by (S/N)², where S is the signal and N is noise, and in this example is about 49.

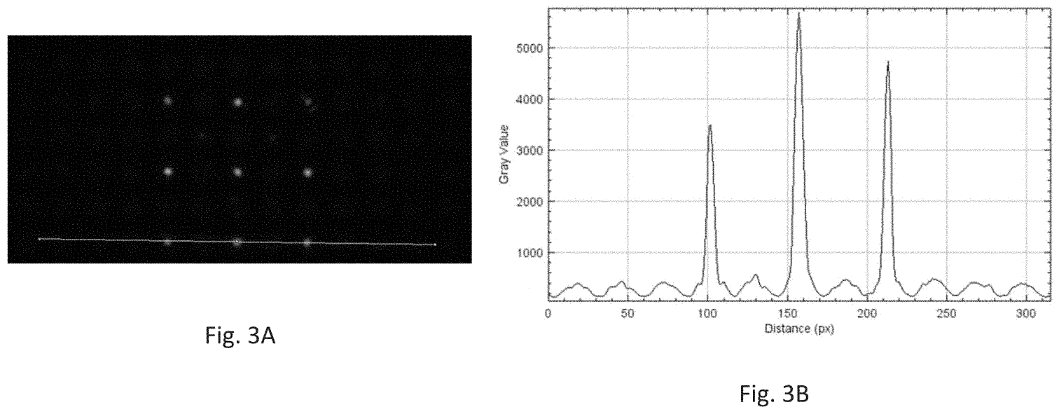

FIG. 3A is a photographed image of a hole pattern (raster) covered by a diffuser, analogues to a 0.5 mm scattering milk layer, imaged by the system of FIG. 1A, with the diffractive optical element. In this image the hole pattern is clearly shown, while noise is very effectively reduced. FIG. 3B is a graph showing the gray scale value across the line (pixel distance) shown in the image of FIG. 3A. It is evident in the graph of FIG. 3B that the hole pattern peaks to an average of about 5000, while noise is greatly reduced and peaks to an average of about 290. Thus, SNR is about 295, which is about 6 times the SNR achieved without the DOE.

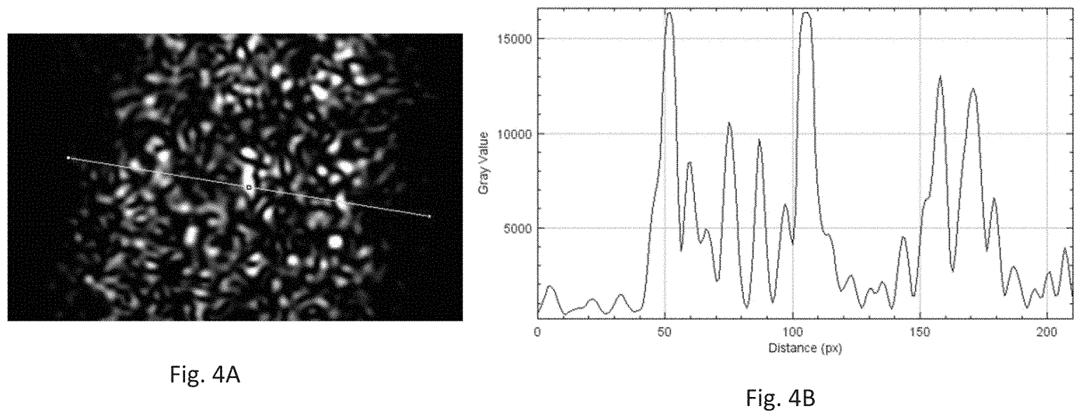

FIG. 4A is a photographed image of a hole pattern (raster) covered by a diffuser with a greater diffusing angle than the diffuser used for FIG. 3A, imaged by the system of FIG. 1A, without the diffractive optical element. Noise in this image is very strong and widely distributed.

FIG. 4B is a graph showing the gray scale value across the line (pixel distance) shown in the image of FIG. 4A. The hole pattern peaks reach up to about 16000, while noise ranges between 3500 to 10000. Thus, SNR is about 5.7.

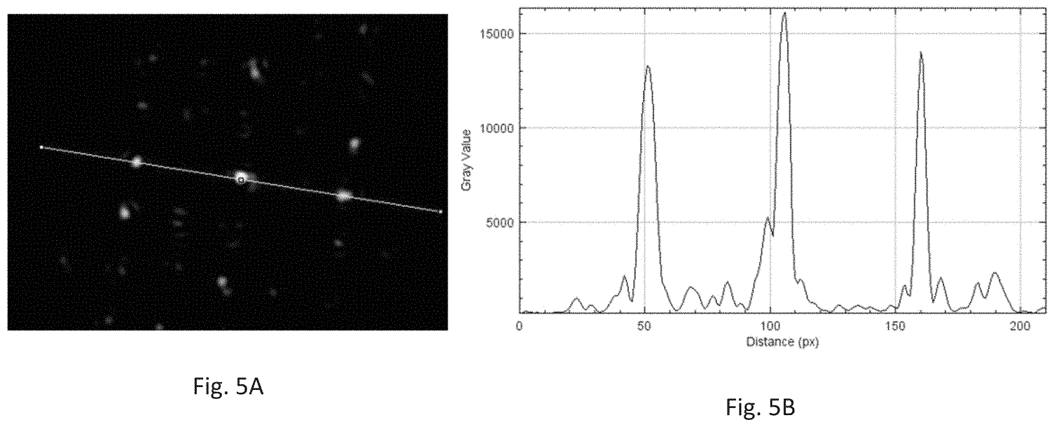

FIG. 5A is a photographed image of a hole pattern (raster) covered by a diffuser with a greater diffusing angle than the diffuser used for FIG. 3A, imaged by the system of FIG. 1A, with the diffractive optical element. FIG. 5B is a graph showing the gray scale value across the line (pixel distance) shown in the image of FIG. 5A. The noise seems to have been greatly reduced, with the hole pattern peaks reaching about 16000, while noise ranges between 1500 and 500. The calculated SNR is about 256, which is about 40 times better than the SNR without the DOE.

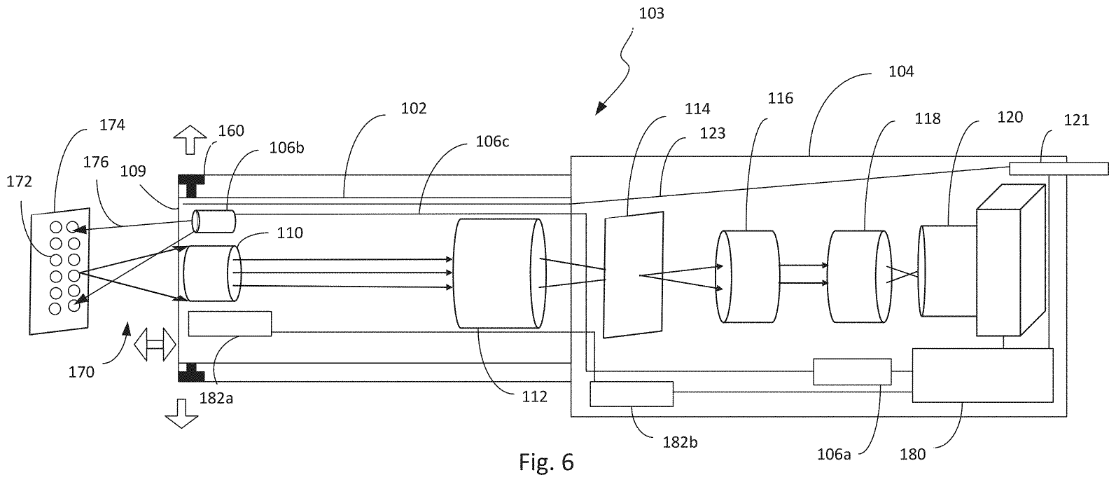

FIG. 6 is a schematic illustration of a system for imaging through a scattering medium, according to some embodiments of the present invention, embodied in an endoscope 103 with an illumination source.

The insertion tube 102 of endoscope 103 may include magnifying optical setup 111, with one or more lenses. e.g., objective lens 110 and ocular lens 112. The magnifying optical setup 111 may be embodies in a single optical fiber or embodied in a multicore fiber. Inspection tube 102 may also include one or a plurality of illumination conduits. e.g., core or fiber 106c, that is optically linked illumination source 106a, e.g., laser source, and has an outlet 106b, through which light, e.g., an illumination beam 176, may illuminate an object 174 to be imaged. In some embodiments of the present invention the DOE, the optical guide set-up and the imaging sensor may be located at a hand-held or automated control body 104 of the endoscope, which may be located outside the subject's body, to which the insertion tube 102 is linked and optically coupled. Controller 180 may be provided to control components of the endoscope, such as the imaging sensor 120, illumination source 106a, and/or other components.

According to some embodiments of the present invention, the illumination source is configured, when the distal end 109 of the insertion tube 102 is inserted inside a cavity to be examined and faces an object 174 to be imaged, to illuminate the object 174. When the distal end 109 of the insertion tube 102 is immersed in a scattering medium (e.g., blood or other scattering body fluid) that fills the space between the distal end 109 of the insertion tube 102 from the object 174, the illumination beam is subjected to scattering by the scattering medium and as a result may project on the object an illumination pattern of an array of dots.

A displacer 160 may be provided at the distal tip of the insertion tube 102 of the endoscope 103, for simultaneously displacing the distal end with the illumination source (e.g., the outlet of the illumination fiber 106c) with the end of the imaging core or cores (e.g., an objective end of the first optical setup of the optical arrangement) in the XY plane or in the Z axis, to facilitate lateral scanning of the object and/or for shifting the plane of imaging along the Z-axis for three-dimensional imaging. The displacer may include, for example a motor and a screw drive or other mechanism to facilitate the motion in the XY plane and/or Z axis.

When illuminating an imaged object by an illumination beam generated by an illumination source, e.g., a laser source, through a scattering medium (e.g., blood) by a laser light that has temporal and spatial coherence, an array of dots may be formed on the object to be imaged.

Light reflected off the imaged object (or transmitted through the object, if the object is located between the illumination source and the imaging device) is also subjected to the scattering effect of the scattering medium, and therefore the obtained image resolution at the imaging sensor is likely to be poor.

According to some embodiments of the present invention, the laser source may be configured to illuminate an object to be imaged, and when the outlet 106b of the illumination conduit shifts laterally or is made to rapidly shift or be shifted (e.g., vibrated) sideways and/or up or down (in the X-Y plane, where Z is substantially parallel to the direction of the illumination beam, XYZ being orthogonal axes) so as to illuminate the object to be imaged with a an array of dots—which are assumed to be essentially the same.

According to some embodiments of the invention, the illumination source illuminates through the scattering medium a time changing pattern D(x,t). This pattern is actually a spot of light (of the laser beam) whose location and amplitude changes in time:

$$D ( x , t ) = a ( t ) rect ( \frac{x - vt}{Δ x} ) \qquad ( 1 )$$

where v is the shifting velocity for the center of the illuminating spot D(x,t) and a(t) is its time changing amplitude.

If the shifts are small, the entire speckle pattern that is generated behind the scattering medium on the object is likely to shift over the surface of the object to be imaged due to memory effect and it will mainly shift as much as the illumination spot shifts otherwise remaining practically unchanged.

The speckle pattern generated behind the scattering medium due to

$$rect ( \frac{x - vt}{Δ x} )$$

may be denoted as: s(x−vt).

Eventually, in a camera a generated image requires a time integration to be performed and thus the overall projected speckle pattern that is generated behind the scattering medium may be denoted by:

∫a(t)s(x−vt)dt (2)

Assuming that these are not fully developed speckles and that the object is located at a distance from the scattering medium and that the pattern P(x) that is projected on the object (located behind the scattering medium) is the Fourier transform of the above-described speckle pattern:

$$P ( x ) = \int ( \int a ( t ) s ( {x}^{′} - vt ) dt ) exp ( \frac{- 2 π {ix}^{′} x}{λ Z} ) {dx}^{′} \qquad ( 3 )$$

Where Z is the distance between the scattering medium and the object to be imaged and A is the optical wavelength. Equation (3) may also be written as:

$$P ( x ) = S ( \frac{x}{λ Z} ) ( \int a ( t ) exp ( \frac{- 2 π ivtx}{λ Z} ) dt ) \qquad ( 4 )$$

Where

$$S ( \frac{x}{λ Z} )$$

is the spatial Fourier transform of s(x) and it is the fully developed speckle pattern (the far field of the not fully developed speckle pattern). It may be noted that the expression that multiplies

$$S ( \frac{x}{λ Z} )$$

is the temporal Fourier transform of a(t), the changing in time amplitude of the illuminated speckle.

According to some embodiments of the present invention the illumination source 106a of the endoscope 103 may be configured (e.g., operated by controller 180) to generate temporally pulsed illumination:

$$a ( t ) = {\sum }_{n} δ ( t - n Δ t ) \qquad ( 5 )$$

Which yields:

$$\int a ( t ) exp ( \frac{- 2 π ivtx}{λ Z} ) dt = {\sum }_{n} δ ( \frac{xv}{λ Z} - \frac{n}{Δ t} ) = {\sum }_{n} δ ( x - n \frac{λ Z}{v Δ t} ) \qquad ( 6 )$$

Finally, the pattern illuminating the inspected object becomes:

$$P ( x ) = S ( \frac{x}{λ Z} ) {\sum }_{n} δ ( \frac{x}{λ Z} - \frac{n}{v Δ t} ) \qquad ( 7 )$$

The projected speckle pattern is therefore discretized by its multiplication with the discrete pattern of

$${\sum }_{n} δ ( \frac{x}{λ Z} - \frac{n}{v Δ t} ) .$$

Practically, according to some embodiments of the present invention, the object to be imaged may be illuminated by a plurality of rapid laser pulses, while the distal end of the insertion tube is shifted, all within the integration time (the time it takes the imaging sensor to output a complete frame) of a single image on an imaging sensor to obtain a single image of the array of spots on the object to be imaged.

For example, for an illumination array of spots having 100 by 100 spots, the laser source ay be configured to generated pulsed laser beam of where 10,000 pulses are generated during an integration time of a single image on the imaging sensor. e.g., for a camera whose acquisition frame rate is 10 frames per second, the integration time is 0.1 second, so the illumination source should generate an illumination beam pulses at 100.000 pulses per second.

The shifting of the distal end of the insertion tube may be achieved, for example, by one or more vibrators 182a and/or 182b, e.g., controlled by controller 180, that may be provided within the endoscope (e.g., vibrator 182 located at the distal end of the insertion tube 102, and/or vibrator 182b located in the control body 104, for example near the coupling position of the insertion tube 102 with the control body 104) so as to cause the distal end of the insertion tube to vibrate when the illumination source is used to illuminate the object to be imaged.

In some embodiments of the invention, the rapid shifting of the distal end 109 of the insertion tube may be achieved in other ways as well, for example, by the natural tremor that may be a result of hand-handling of the endoscope.

A system for imaging through a scattering medium, according to some embodiments of the present invention facilitates obtaining images of coplanar parts of the object to be imaged with good (high) SNR.

According to some embodiments of the present invention, three-dimensional imaging may be performed with the system for imaging through a scattering medium, by performing scanning in the Z-axis, collecting planar images of the imaged object and combining the scanned image data to produce a three-dimensional image.

According to some embodiments of the invention the endoscope may include a guide wire 123, for manipulating the distal end of the insertion tube 102, for example by shifting the distal end laterally in the X-Y plane. Guide wire 123 may be operated manually or automatically by a guide wire actuator 121. In some embodiments of the present invention the guide wire 123 may be used for vibrating the distal end of the insertion tube 102 to obtain rapid lateral shifts (instead of, for example, a vibrator).

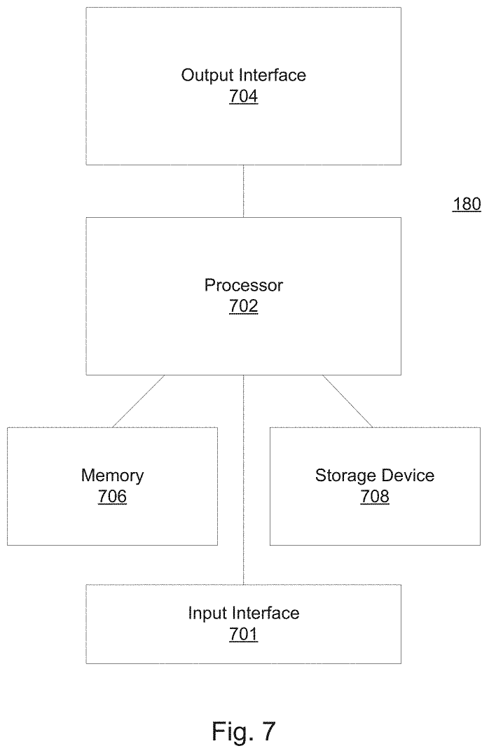

FIG. 7 is a block diagram of a controller 180 that may be incorporated in a system for imaging in scattering medium, according to some embodiments of the invention. System 700 may also include input interface 701, for connecting to an imaging system for obtaining image data from the image sensor and/or for obtaining data and/or commands from a user. System 700 may include a processor 702 (e.g. single processor or a plurality of processors, on a single machine or distributed on a plurality of machines) for processing the image data obtained from the imaging sensor, and/or for executing one or more additional methods according to some embodiments of the present invention. Processor 702 may be configured to perform a method according to some embodiments of the present invention and perform other actions and processing according to some embodiments of the present invention.

Processor 702 may be linked with memory 706 on which a program implementing a method according to some embodiments of the present invention and corresponding data may be loaded and run from, and storage device 708, which includes a non-transitory computer readable medium (or mediums) such as, for example, one or a plurality of hard disks, flash memory devices, etc. on which a program implementing a method according to some embodiments of the present invention and corresponding data may be stored. System 700 may further include an output device 704 (e.g. another computing device, a communication module for communicating over a network with a remote computing device, a display device such as CRT, LCD, LED, OLED etc.) for outputting images or other data or information.

Some embodiments of the present invention may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with examples. In some examples, the instructions stored on the computer readable medium may be in the form of an installed application and in the form of an installation package.

Such instructions may be, for example, loaded by one or more processors and get executed.

For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

Some embodiments are described hereinabove with reference to flowcharts and/or block diagrams depicting methods, systems and computer program products according to various embodiments.

Features of various embodiments discussed herein may be used with other embodiments discussed herein. The foregoing description of the embodiments has been presented for the purposes of illustration and description. It is not intended to be exhaustive or limiting to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes that fall within the true spirit of the present invention.

1. A system for imaging through a scattering medium, the system comprising:
a spatial and temporal coherent light source for generating an illumination beam to illuminate an object to be imaged through a scattering medium, so as to project an array of spots on the object;
an imaging sensor for capturing an image of the object;
an optical arrangement comprising:
a first optical setup to capture light transmitted through or reflected off the object and focus the captured light onto a diffractive optical element (DOE) configured to transmit ballistic photons of the captured light arriving from the object while blocking scattered photons; and
a second optical setup to capture light transmitted by the DOE and focus that light onto an imaging plane of the imaging sensor.

2. The system of claim 1, wherein the DOE comprises an array of diffractive lenses.

3. The system of claim 2, wherein the array of diffractive lenses comprises rows and columns of diffractive lenses.

4. The system of claim 3, wherein the diffractive lenses are located at intersections of the rows and columns.

5. The system of claim 2, wherein each diffractive lens is defined by a circular edge and comprises a toroidal groove surrounding a central circular raised plateau.

6. The system of claim 1, wherein the light source is a laser source.

7. The system of claim 6, wherein the laser source is a pulsed laser source.

8. The system of claim 6, further configured to cause the illumination source and the optical arrangement to perform rapid lateral shifts in a plane substantially orthogonal to a direction of the illumination beam.

9. The system of claim 8, further comprising one or more vibrators to cause the lateral shifts.

10. The system of claim 1, further comprising a displacer to displace the light source and an objective end of the optical arrangement to perform scanning of the object.

11. The system of claim 10, wherein the displacer is configured to displace the light source and the objective end of the optical arrangement in a plane substantially orthogonal to a direction of the illumination beam.

12. The system of claim 10, wherein the displacer is configured to displace the light source and the objective end of the optical arrangement along an axis substantially parallel to a direction of the illumination beam.

13. The system of claim 1, incorporated in an endoscope.

14. A method for imaging through a scattering medium, the method comprising:
generating by a spatial and temporal coherent light source an illumination beam to illuminate an object to be imaged through a scattering medium, so as to project an array of spots on the object;
capturing by a first optical setup of an optical arrangement light transmitted through or reflected off the object and focusing the captured light onto a diffractive optical element (DOE) configured to transmit ballistic photons of the captured light arriving from the object while blocking scattered photons;
capturing by a second optical setup of the optical arrangement light transmitted by the DOE and focusing that light onto an imaging plane of an imaging sensor; and
capturing the focused image by the imaging sensor.

15. The method of claim 14, wherein the DOE is an array of diffractive lenses.

16. The method of claim 15, wherein each diffractive lens of the array is defined by a circular edge and comprises a toroidal groove surrounding a central circular raised plateau.

17. The method of claim 14, wherein the light source is a laser source.

18. The method of claim 17, wherein the laser source is a pulsed laser source.

19. The method of claim 18, further comprising causing the illumination source and the optical arrangement to perform lateral shifts in a plane substantially orthogonal to a direction of the illumination beam.

20. The method of claim 19, wherein causing the illumination source and the optical arrangement to perform lateral shifts comprises using one or more vibrators.

21. The method of claim 14, further comprising displacing the light source and an objective end of the optical arrangement by a displacer to perform scanning of the object.

22. The method of claim 21, wherein the displacing comprises displacing the light source and the objective end of the optical arrangement in a plane substantially orthogonal to a direction of the illumination beam.

23. The method of claim 21, wherein the displacing comprises displacing the light source and the objective end of the optical arrangement along an axis substantially parallel to a direction of the illumination beam.
